(19) United States
(12) Patent Application Publication
(10) Pub. No.: US 2026/0004665 A1
(43) Pub. Date: Jan. 1, 2026

(54) Aircraft Operational State Detection Based on Aircraft Movement

(71) Applicant: Joby Aero, Inc., Santa Cruz, CA (US)

(72) Inventor: Christabelle Simone Juliette Bosson, Mountain View, CA (US)

(21) Appl. No.: 19/256,863

(22) Filed: Jul. 1, 2025

Related U.S. Application Data
(60) Provisional application No. 63/666,465, filed on Jul. 1, 2024.

(51) Int. Cl. G08G 5/34

(52) U.S. Cl. CPC G08G 5/34

(57) ABSTRACT

A method for detecting an aircraft operating state includes computing an operating state for the aircraft based on data corresponding to a position and a velocity of the aircraft and data corresponding to a scheduled flight operation for the aircraft. An updated flight event log for the aircraft may be computed based on the operating state for the aircraft.

### CROSS-REFERENCE TO RELATED APPLICATION

The present application is related and has right of priority to U.S. Provisional Patent Application No. 63/666,465, which was filed on Jul. 1, 2024 and is incorporated by reference in its entirety for all purposes.

### FIELD

The present disclosure relates generally to aircraft operation state detection. For example, the present disclosure utilizes telemetry data and/or scheduled operation data to compute the operating state for aircraft.

### BACKGROUND

Tracking flight start and end times can assist with aircraft operations. For instance, the start and end times can be used to calculate flight times, understand service consistency, and calculate pilot flight hours. Conventionally, pilots manually determine flight start and end times. For instance, the pilot may track when an aircraft engine starts to determine the flight start time, and the pilot may track when the aircraft lands to determine the flight end time. This manual process can be cumbersome and subject to error.

### SUMMARY

Aspects and advantages of implementations of the present disclosure will be set forth in part in the following description, or may be learned from the description, or may be learned through practice of the implementations.

One example aspect of the present disclosure is directed to a method for computing an aircraft operating state. The method includes accessing, with one or more computing devices, data corresponding to a position and a velocity of a telemetry system for an aircraft. The method also includes accessing, with the one or more computing devices, data corresponding to a scheduled flight operation for the aircraft. The method further includes computing, with the one or more computing devices, an operating state for the aircraft based on at least one of the data corresponding to the position and the velocity of the aircraft for the telemetry system or the data corresponding to the scheduled flight operation for the aircraft. The method may also include computing, with the one or more computing devices, an updated flight event log for the aircraft based on the operating state for the aircraft.

In some example implementations, the telemetry system may include an automatic dependent surveillance-broadcast system of the aircraft.

In some example implementations, the scheduled flight operation for the aircraft may include a scheduled time of departure for the aircraft.

In some example implementations, the operating state for the aircraft may include one of: an off-block operating state; a takeoff operating state; a landing operating state; or an in-block operating state.

In some example implementations, each of the off-block operating state, the takeoff operating state, the landing operating state, and the in-block operating state may be computed no greater than two minutes from a respective actual operating state time.

In some example implementations, the method may further include computing, with the one or more computing devices, an average block time for the aircraft based on the off-block operating state and the in-block operating state.

In some example implementations, the method may further include computing, with the one or more computing devices, a flight time of a pilot of the aircraft based on the takeoff operating state and the landing operating state.

In some example implementations, the method may further include computing, with the one or more computing devices, an updated flight plan for the aircraft based on at least one of an average block time or an average flight time.

In some example implementations, the method may further include: accessing, with the one or more computing devices, data corresponding to the position for the aircraft in response to detection of the landing operating state; and computing, with the one or more computing devices, a diversion of the aircraft from the scheduled flight operation when the position for the aircraft does not match a scheduled destination for the aircraft.

In some example implementations, the method may further include computing, with the one or more computing devices, a touch-and-go log update for the aircraft based on the takeoff operating state and the landing operating state.

In some example implementations, computing the operating state for the aircraft may include computing the operating state for the aircraft based on the data corresponding to the scheduled flight operation for the aircraft when the data corresponding to the position and the velocity of the aircraft for the telemetry system is older than a threshold time period.

In some example implementations, the method may further include adjusting the updated flight event log for the aircraft based on an override input by a pilot of the aircraft.

It will be understood that two, three, four, or more of the example implementations of the example method(s) may be combined in example aspects of the present disclosure.

Another example aspect of the present disclosure is directed to a computing system that includes one or more processors and one or more non-transitory computer-readable media storing instructions that are executable by the one or more processors to perform operations. The operations include: accessing data corresponding to a position and a velocity of an telemetry system for an aircraft; accessing data corresponding to a scheduled flight operation for the aircraft; computing an operating state for the aircraft based on at least one of the data corresponding to the position and the velocity of the aircraft for the telemetry system or the data corresponding to the scheduled flight operation for the aircraft; and computing an updated flight event log for the aircraft based on the operating state for the aircraft.

In some example implementations, the operations may include any one or more of the example method(s).

Yet another example aspect of the present disclosure is directed to one or more non-transitory, computer-readable media storing instructions that are executable by one or more processors to cause the one or more processors to perform operations. The operations include: accessing data corresponding to a position and a velocity of an telemetry system for an aircraft; accessing data corresponding to a scheduled flight operation for the aircraft; computing an operating state for the aircraft based at least one of the data corresponding to the position and the velocity of the aircraft for the telemetry system or the data corresponding to the scheduled flight operation for the aircraft; and computing an updated flight event log for the aircraft based on the operating state for the aircraft.

In some example implementations, the operations may include any one or more of the example method(s).

Other example aspects of the present disclosure are directed to other systems, methods, vehicles, apparatuses, tangible non-transitory computer-readable media, and devices for using aircraft route, velocity, and/or position data to determine aircraft operating states, as well as controlling aircraft and other vehicles associated therewith.

These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 depicts an example multi-modal transportation service according to example implementations of the present disclosure;

FIG. 2A depicts an example computing ecosystem according to example implementations of the present disclosure;

FIGS. 2B-C depict example computing device registers according to example implementations of the present disclosure;

FIG. 3 depicts an example dataflow pipeline according to example implementations of the present disclosure;

FIGS. 4A-C depict example data structures according to example implementations of the present disclosure;

FIG. 5 depicts an example aerial transportation service according to example implementations of the present disclosure;

FIGS. 6A-D depict flowchart diagrams of example computer-implemented methods according to example embodiments of the present disclosure; and

FIG. 7 depicts a block diagram of an example computing system according to example embodiments of the present disclosure.

### DETAILED DESCRIPTION

Generally, the present disclosure is directed to techniques for aircraft operation state detection. An aircraft operation state can indicate key transitions or events during a trip. This technology can assist with detecting aircraft operation states in real-time and adjusting various operating parameters of the aircraft based upon the detected operation states. Moreover, the technology may be used for a fleet of aircraft within a dense operating environment. For instance, a fleet of vertical takeoff and landing (VTOL) aircraft can be used to transport riders within busy metropolitan areas. In such an environment, pilots are busy with aircraft operations, and manually tracking and updating aircraft operating states can be difficult. As such, the technology of the present disclosure provides accurate and timely determination of aircraft operating states in dynamic, fast-paced conditions. This can allow for improved computational efficiency of the aircraft's onboard computing systems, as well as the centralized computing systems programmed for planning aircraft operations across an entire fleet.

An aircraft operation state detection system can use real-time data to track and update the current operation state of the aircraft. Various operation states may be detected. For instance, an off-block operating state may correspond to when the aircraft moves from a parked position, such as when the aircraft is loaded, ready for departure, and moves away from the parking position towards a take-off position. As another example, a takeoff operating state may correspond to when the aircraft leaves the ground, such as when the aircraft powers up and takes flight. As another example, a landing operating state may correspond to when the aircraft touches down from flight, such as when the aircraft arrives at a destination and lands on a pad, strip, etc. As another example, an in-block operating state may correspond to when the aircraft arrives into a parked position. This can include when the aircraft completes taxiing or the aircraft is done being towed to a parking position and stops moving. Such operation states may cover key transitions or events during a travel route of the aircraft from an origin location to a destination location. It will be understood that other operation states may also be detected.

A computing system can access data from various sources to detect the aircraft operation states. For example, the computing system can access telemetry data from one or more of a System Wide Information Management (SWIM) system, an avionic system of the aircraft, a high resolution radar (HRR) system, an Automatic Dependent Surveillance-Broadcast (ADS-B) system, an LTE Cube system, a pilot device, the Global Positioning System (GPS), the Wide Arca Augmentation System (WAAS), or other sources of position and velocity data for the aircraft. As another example, the computing system can access a flight schedule for the aircraft, that includes one or more of an expected departure time, an expected takeoff time, an expected time in the air, an expected landing time, and an expected arrived time.

The various data sources may be evaluated and ranked for reliability. For example, the data sources may be evaluated and ranked for accuracy and reliability such that the ranking reflects the ability of the various data sources to detect the current aircraft operation state within two minutes of the actual aircraft operation state change.

The computing system can track aircraft operation states and update operation plans in real-time to facilitate aircraft operations. For example, when the aircraft begins operation, the computing system can access data indicating a change in velocity and position of the aircraft and/or data indicating a scheduled change in velocity and position of the aircraft. The computing system can detect the current operating state of the aircraft, e.g., the off-block operating state, the takeoff operating state, the landing operating state, or the in-block operating state. The computing system can also detect any changes in the operating state of the aircraft.

Using this information, the computing system can update a flight event log for the aircraft. The flight event log can capture flight start and end times, which can assist with tracking total flight time for pilot hour requirements, maintenance intervals, and other purposes. This can be done in an automated manner.

The computing system can also update operations data based upon the detected operation states for the aircraft. For instance, the computing system can update an arrival time of the aircraft at a destination location, a subsequent departure time for the aircraft from the destination location, etc. The operations data can be transmitted to passenger(s) to update the passenger(s) regarding aircraft operations. This can be done in an automated manner. The computing system can also compute updated actions for other aircraft in a fleet based on the detected operation state for a particular aircraft. By way example, the computing system can determine that a first aircraft has entered its current operation state (e.g., in-block operating state) indicating that the aircraft is behind schedule. The computing system may determine whether the first aircraft's delay is greater than a threshold amount, such that downstream flights/passengers would be significantly impacted. A passenger may be considered to be significantly impacted if, for example, the delay would cause the passenger to arrive later than their estimated time of arrival at their ultimate destination, after taking ground-based transportation from a landing location to their ultimate destination. This computation may include the computing system calling an API to determine the estimated wait time, travel time, etc. associated with ground-based transportation from the landing location. If the delay may significantly impact a passenger, the computing system can compute an updated action for a second aircraft. This can include the second aircraft being assigned to a future flight or to transport impacted passengers, which were previously assigned to the delayed aircraft. These assignments can be implemented by writing new data entries into the data fields that define the various flight plans/schedules and manifests of the second aircraft, and transmitting updated information (including route information) to the second aircraft.

The technology of the present disclosure can provide a number of technical effects and improvements to computing and aircraft technology. For instance, the technology of the present disclosure can compute operation states for a fleet of aircraft based upon position and velocity data and/or scheduled position and velocity data for each aircraft. An aircraft operation state detection system can ingest this data to determine the departure/arrival times for the fleet of aircraft in real-time. In this way, the technology of the present disclosure provides an improved approach for automatically determining aircraft operation states in a manner that is quick and reliable. Moreover, the technology of the present disclosure can select one or more of a variety of data sources to utilize one, two, three or more data sources that provide reliable and redundant position and velocity data for the aircraft. Thus, the technology of the present disclosure can compute operation states for each aircraft in the fleet of aircraft within two minutes of any actual aircraft operation state change. This also allows the aircraft operation state detection system to provide an accurate, up-to-date view of the operation states for the fleet of aircraft in real-time.

Moreover, the technology of the present disclosure can allow aircraft operators to focus on more discrete tasks while operating the aircraft, help improve real-time control decisions, while minimizing the effects of changes in flight operations of the overall transportation operations. Ultimately, the automation provided by the present disclosure can increase computational efficiencies for both a network system and onboard the aircraft, while also increasing coordination among the fleet, and reducing pilot burden when performing a transportation service.

Further, the technology of the present disclosure can improve the functionality of the computing infrastructure configured to plan and manage aircraft operations. More specifically, an aircraft operation planning system can utilize the aircraft operation state detection system to implement a customized solution for automatically generating updated flight plans for the fleet of aircraft that are specifically tailored for the current operation states for the fleet of aircraft. This can improve computational efficiency and avoid computational re-work. This is particularly valuable the complex computing systems that are planning flight operations for an on-demand transportation service, in a dense urban environment, where computation times are constrained by the real-time, on-demand nature of the flight operations.

### Example Transportation Service

A fleet of aircraft can perform a transportation service to transport riders to requested destinations. This can include an on-demand transportation service that is provided within a dense urban environment, with shorter flights, and at lower altitudes than those typically provided by commercial airlines. One example on-demand transportation service can include a multi-model transportation service.

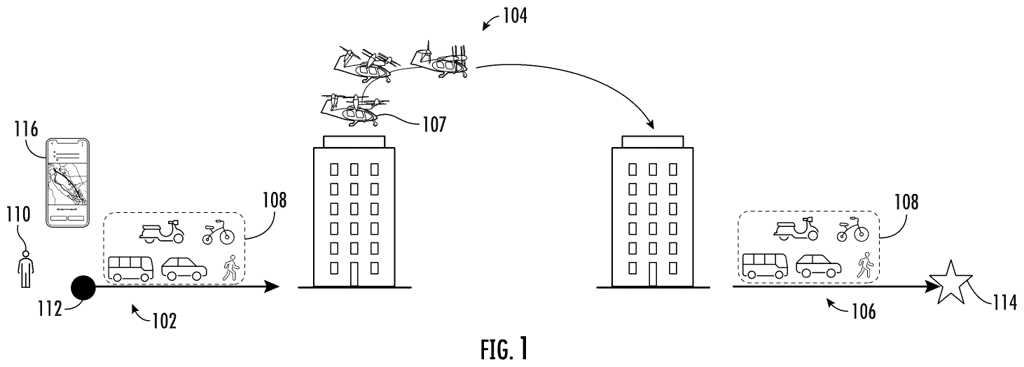

FIG. 1 depicts an example process flow of a multi-modal transportation service according to example implementations of the present disclosure. A multi-modal transportation service can include multiple transportation legs 102, 104, 106 associated with at least two different transportation modalities. For example, the multi-modal transportation service can include a first transportation leg 102, one or more second transportation legs 104, and a third transportation leg 106.

A combination of ground vehicles, aircraft, or other types of vehicles can perform the various legs of the multi-modal transportation service. Each transportation leg of the multi-modal transportation service can be associated with a respective transportation modality. For instance, the first transportation leg 102 can be associated with a first transportation modality using one or more of ground vehicles 108 such as an automobile. A second transportation leg 104 can be associated with a second transportation modality using an air-based modality such as an aircraft 107. The third transportation leg 106 can be associated with a third transportation modality, which can be the same or different from the first or second modalities. For example, the third transportation leg 106 can use a ground modality such as another automobile, bicycle, walking route, etc.

The aerial transport can include one or more different aircraft such as airplanes, vertical take-off and landing vehicles (“VTOLs”), or other aircraft including conventional take-off and landing vehicles (“CTOLs”). VTOLs, for example, can include one or more different types of rotorcraft (e.g., helicopters, quadcopters, gyrocopters, etc.), tilt-rotor aircraft, powered-lift vehicles, and/or any other vehicle capable of vertically taking-off and/or landing (e.g., without a runway).

As shown in FIG. 1, the aircraft used in the multi-modal transportation service can include a VTOL that is configured to operate in multiple flight modes. For example, an aircraft can include multirotor configurations such that the position, orientation, etc. of the aircraft's rotors can be adjusted to allow the aircraft to operate in the various flight modes. This can include, for example, a first rotor position that allows the aircraft to take-off, land, or hover vertically (e.g., in a hover mode) and a second rotor position that allows the aircraft to travel forward using a thrust force (e.g., in a cruise mode). This can allow the aircraft to take-off and land vertically or perform a conventional take-off and landing.

The aircraft can include one or more types of power sources such as batteries, a combustible fuel source, electrochemical sources (such as a hydrogen fuel cell system), or a combination thereof. For example, the aircraft can include electric VTOLs (“eVTOLs”) capable of operating using one or more electric batteries, VTOLs capable of operating using combustible fuel, or VTOLs using hybrid propulsion systems.

The multi-modal transportation service can be provided in an on-demand manner. The service can include a ridesharing, ride-hailing, vehicle reservation, or delivery service. The multi-modal transportation service can be coordinated for a user 110 by one or more service providers.

A service provider can be an entity that offers, coordinates, manages, etc. a transportation service. This can include a transportation network company, vehicle fleet manager, etc. For example, a user 110 may desire to travel on a journey from an origin location 112 to a destination location 114. The user 110 can interact with a user device 116, via a user interface of a software application, to book transportation for the journey. The user 110 can interact with user device 116 over one or more user sessions.

Based on the user sessions, at least one service entity can compile one or more options for the user 110 to traverse the journey. The user device 116 of the user 110 may present these options to the user 110 via a user interface of the software application. At least one option for the journey can include the multi-modal transportation service. Responsive to selection of the multi-modal transportation service option by the user 110, the service can be initiated for transportation for user 110.

To track and coordinate the multi-modal transportation service, a user itinerary can be computed for the user 110. A user itinerary (also referred to as a “multi-modal itinerary”) can be defined by a data structure that includes various information associated with a user's trip from an origin location to a destination location. As used herein, user itinerary may refer to the user itinerary or the underlying data structure depending on the context. The user's itinerary may include: identifiers for locations of interest (e.g., names/coordinates for origins, destinations, vertiports, etc.), times/durations the user is at each location, transportation modalities, specific vehicle assignments, seat assignments, real-time location data, luggage information, or other information. The user itinerary can be updated in real-time as the user 110 progresses along the journey, in response to any changes to the journey, etc. The user itinerary can be available to the user 110 via the user device 116.

Building user itineraries on-demand across modalities can involve centralized or distributed scheduling of resources associated with each modality. For instance, example implementations can involve systems and devices that interface with user 110, systems and devices associated with a first modality of transportation, and systems and devices associated with a second modality of transportation.

The itinerary of the user 110 can be based on the user's origin location, destination location, available intermediate locations for transitioning between transportation modalities, vehicle routes, and/or other information.

### Example Computing Ecosystem for Coordinating Transportation Services

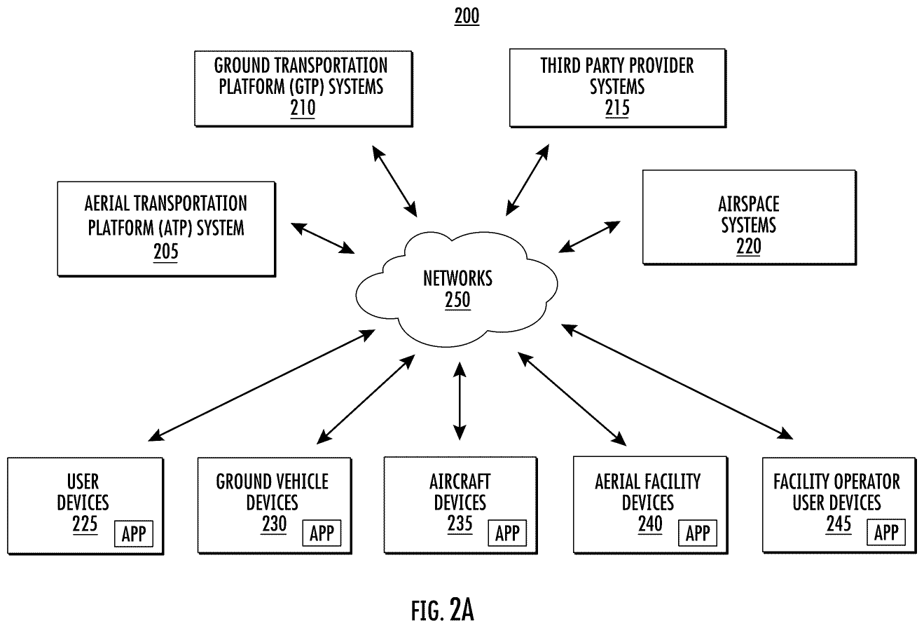

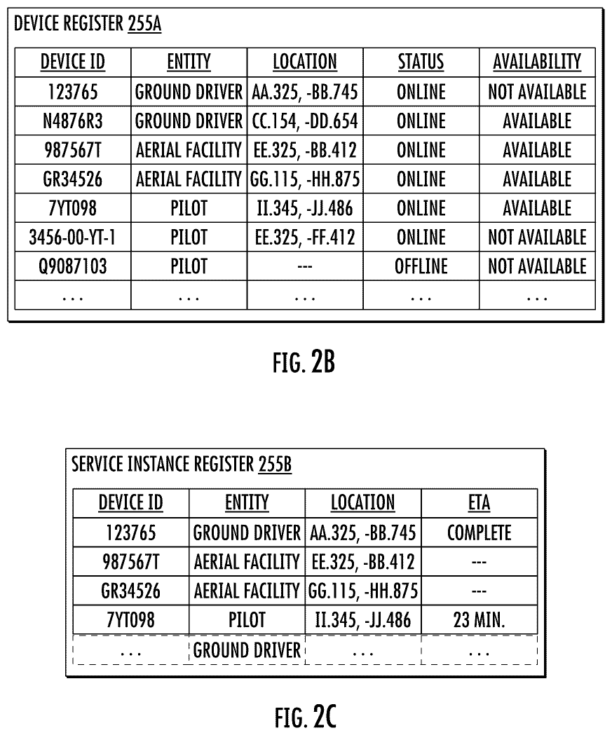

Coordinating aircraft to provide transportation services can include a distributed computing network. FIG. 2A depicts a block diagram illustrating an example networked ecosystem 200 for cross-platform coordination for transportation services. Multiple network-connected systems can cooperatively interact within ecosystem 200 to provide transportation services. As shown, ecosystem 200 may include a distributed computing system with a plurality of different participating systems/devices communicatively connected over one or more networks 250.

The ecosystem 200 can include one or more transportation platform systems such as, for example, an aerial transportation platform (ATP) system 205 and one or more ground transportation platform (GTP) systems 210. The ecosystem 200 can include third-party provider systems 215, airspace systems 220, user devices 225, ground vehicle devices 230, aircraft devices 235, aerial facility devices 240, or facility operator user devices 245.

Each of the systems or devices can communicate over one or more wireless or wired networks 250. Networks 250 can include one or more types of networks including telecommunications networks, internet, private networks, or other networks, as further described herein.

The systems and devices of ecosystem 200 can include a plurality of software applications operating on the respective systems and devices. This can create an ecosystem of applications for providing and coordinating a multi-modal transportation services, as further described herein.

User devices 225 can include computing devices owned or otherwise accessible to a user of a transportation service. For example, a user device 225 can include a hand-held computing device (e.g., a phone, a tablet, etc.), a wearable computing device (e.g., smart watch, smart glasses, etc.), personal desktop devices, or other devices. User devices 225 can execute one or more instructions to run an instance of a software application for a respective transportation platform and present user interfaces associated therewith. User devices 225 can include personal devices (e.g., a mobile device) or shared devices on which a user has initiated a personal session (e.g., by logging into a public kiosk or display device in a vehicle, etc.).

A GTP system 210 can be associated with a service entity that provides a ground transportation service. GTP systems 210 can include a computing platform (e.g., a cloud services platform, server system, etc.) communicatively connected over networks 250 to one or more of the systems or devices of networked ecosystem 200.

GTP systems 210 can include or implement one or more client-facing software applications accessible to the devices of ecosystem 200. Users can interact with the GTP systems 210 (e.g., using user devices 225, ground vehicle devices 230, aircraft devices 235) to receive various types of transportation services (e.g., delivery, ridesharing, or ride-hailing, etc.) including multi-modal transportation services. For example, a GTP system 210 can match one of its associated ground vehicles or operators with users for a ground transportation service.

GTP systems 210 can be associated with ground infrastructure for facilitating the performance of a ground transportation service. The ground infrastructure can include one or more parking areas, vehicle transfer hubs, charging/fueling locations, storage facilities, etc.

GTP systems 210 can be associated with a fleet of ground vehicles and the vehicle operators can include a network of ground vehicle operators. As described herein, ground vehicles can include automobiles, bikes, scooters, autonomous vehicles, etc. The network of ground vehicle operators can include drivers or remote operators that facilitate, oversee, or control the movement of ground vehicles available to perform ground transportation services.

Ground vehicle devices 230 can include computing devices or systems associated with a ground vehicle or operator. For example, ground vehicle devices 230 can include one or more vehicle computing systems such as, for example, an onboard computer for operating the vehicle, an autonomy system, an infotainment system, etc. Additionally, or alternatively, ground vehicle devices 230 can include an operator's user device. For example, a ground vehicle device can be a driver's mobile phone. In some implementations, ground vehicle devices 230 can include a user device that remains onboard a ground vehicle such as, for example, a tablet that is available to an operator or passenger.

An ATP system 205 can be associated with one or more service entities that provide at least an aerial transportation service to users. ATP system 205 can include a computing platform (e.g., a cloud services platform, server system, etc.) communicatively connected over networks 250 to one or more of the systems or devices of networked ecosystem 200.

ATP systems 205 can include or implement one or more client-facing software applications accessible to the devices of ecosystem 200. Users can interact with ATP system 205 (e.g., using user devices 225, ground vehicle devices 230, aircraft devices 235) to receive various types of information related to a transportation service. For example, a user (e.g., a rider) can interact with ATP system 205 via an instance of a software application (e.g., a rider app) running on user device 225 to request and book a transportation service. A facility operator can interact with ATP system 205 via an instance of a software application (e.g., an operations app) running on an aerial facility device 240 or a facility operator user device 245 to view/adjust flight information, seat assignments, etc.

In some implementations, the software application of one system can be run within or accessed by the software application of another system. For example, a user interface of a software application associated with an ATP system 205 can be embedded within and displayed with the user interface of the software application associated with the GTP system 210, or vice versa. This can allow a user to utilize one application, while accessing another for a particular transportation leg (e.g., aerial transport).

ATP systems 205 can be associated with one or more aircraft, aircraft operators, aerial facilities (or portions thereof), facility operators, etc. for facilitating the performance of at least an aerial transportation service. For example, the aircraft can include a fleet of aircraft and the vehicle operators can include a network of aircraft operators. The network of aircraft operators can include pilots or remote operators that facilitate, oversee, or control the movement of aircraft available to perform aerial transportation services.

Aerial facilities used for providing a transportation service can include one or more aerial facility devices 240. Aerial facility devices 240 can be positioned at various locations within or around the aerial facility to collect and receive information associated with an aerial transportation service. Aerial facility devices 240 can include one or more charging devices associated with charging infrastructure of the aerial facility, one or more vehicle positioning devices (e.g., motorized tugs, etc.), one or more sensors or surveillance devices (e.g., noise sensors, cameras, etc.), etc.

Aerial facility devices 240 can include a computing system associated with a particular aerial facility. The computing system can maintain a data structure that is indicative of the total capacity of the aerial facility (e.g., how many aircraft can possibility be located at, stored, etc.) and the current capacity (e.g., which/how many aircraft are currently located, stored, etc. at the facility). Such information can be provided to the aerial facility devices 240 by an ATP system 205. This can allow the aerial facility to maintain an understanding of its real-time capacity via a local computing system.

Facility operators can be associated with an aerial facility to assist users with security checks, check-ins, boarding/de-boarding, performing aircraft checks, etc. The facility operator user devices 245 can include user devices utilized by the facility operators. Facility operator user devices 245 can be used to communicate with a transportation platform or perform various functions at an aerial facility. For example, facility operator user devices 245 can run one or more software applications to complete security checks, check in/out luggage, coordinate re-charging/re-fueling, present safety briefings, or the like.

Aircraft devices 235 can include one or more aircraft computing systems or aircraft operator user devices. For instance, aircraft devices 235 can include a computing system onboard an aircraft such as a pilot interface, an avionics system, an infotainment system, a navigation system, an autonomy system, or any other sensors or devices located on an aircraft and capable of sending or receiving information. Aircraft devices 235 can include an aircraft operator's user device (e.g., a pilot's mobile phone). Aircraft devices 235 can include a user device that remains onboard the aircraft such as, for example, a tablet or display that is available to a passenger or operator.

The ecosystem 200 can include one or more airspace systems 220. Airspace systems 220 can include one or more airspace data exchanges or otherwise be associated with regulatory bodies configured to collect real-time, historical, or regulatory airspace data. The airspace systems 220 can include, for example: (i) aggregating systems that pool airspace data associated with an airspace; (ii) third-party monitoring systems configured to monitor aspects of an airspace (e.g., noise, etc.); or (iii) regulatory systems that can confirm, validate, or approve an aerial transportation service before take-off based on one or more policies or standards set by a regulatory body (e.g., Federal Aviation Administration, European Aviation Safety Agency, etc.). In some implementations, the airspace system 220 can be associated with a weather service that provides weather data associated with an airspace in which the aircraft are, or will be, operating.

The ecosystem 200 can include one or more third-party provider systems 215. Third-party provider systems 215 can be associated with one or more third parties that provide resources to ATP systems 205 or GTP systems 210. For example, third-party provider systems 215 can be associated with a third-party aircraft provider, including one or more “third-party” aircraft. Third party aircraft can include aircraft provided, leased, loaned, or otherwise made available by an entity for use by ATP systems 205 for transportation services, as further described herein.

Additionally, or alternatively, third-party provider systems 215 can be associated with a provider of one or more third-party aircraft operators. Third-party aircraft operators can include, for example, a plurality of aircraft pilots that may be available to ATP systems 205 for operation of an aircraft for the transportation services.

In some implementations, third-party provider systems 215 can be associated with a third-party facility provider that can provide facilities (or facility resources) for use in performing transportation services. For example, the third-party facility provider can own, operate, etc. one or more aerial facilities (or portions thereof) that can be rented, leased, or otherwise utilized by a transportation platform system for providing an aerial transportation service. ATP systems 205 or GTP systems 210 can communicate directly or indirectly (e.g., through third-party provider systems 215) with the third-party aircraft, operators, or infrastructure.

The systems and devices of ecosystem 200 may be registered for potential use when providing and coordinating a transportation services. FIG. 2B illustrates an example device register 255A. Device register 255A can include a table or other data structure indicating devices/systems participating in the on-demand transportation platform ecosystem, such as ecosystem 200. Device register 255A can include fields such as Device ID, Entity, Location, Status, Availability, etc.

The device register 255A can be maintained in a local or remote database. Systems and devices can register for participation in ecosystem 200 by providing information to a registration service. Such information can include system/device identifiers, associated entities, IP addresses, downloading an application, signing-up or creating an account, or other information for identifying and communicating with the system/device. The device register 255A can be updated to provide a real-time reference for the characteristics and status of participating systems/devices. This can include, for example, determining whether a device is online or offline (e.g., powered on and connected, or not) or whether the device is available (e.g., not currently being utilized for another task) or unavailable (e.g., being utilized for another task).

A service instance register can be created, such as an example service instance register 255B shown in FIG. 2C. A service instance register 255B can include a data structure with one or more data objects that indicate the devices to be utilized for facilitating and progressing a user along their journey.

An ATP system 205 (or another system) can build a service instance register 255B for servicing a particular service request. Service instance register 255B can be associated with a unique or distinct service instance identifier for a particular user itinerary for providing at least one leg of a transportation service. Service instance register 255B can assemble a selection of participating devices from device register 255A. Service instance register 255B can include a minimum set of participating devices to complete at least a leg of a journey. Service instance register 255B may include all participating devices to complete the entire leg of a journey. This can include, for example, the aerial facility devices 240 for any origin and destination aerial facilities.

### Example Computing System for Aircraft Operating State Detection

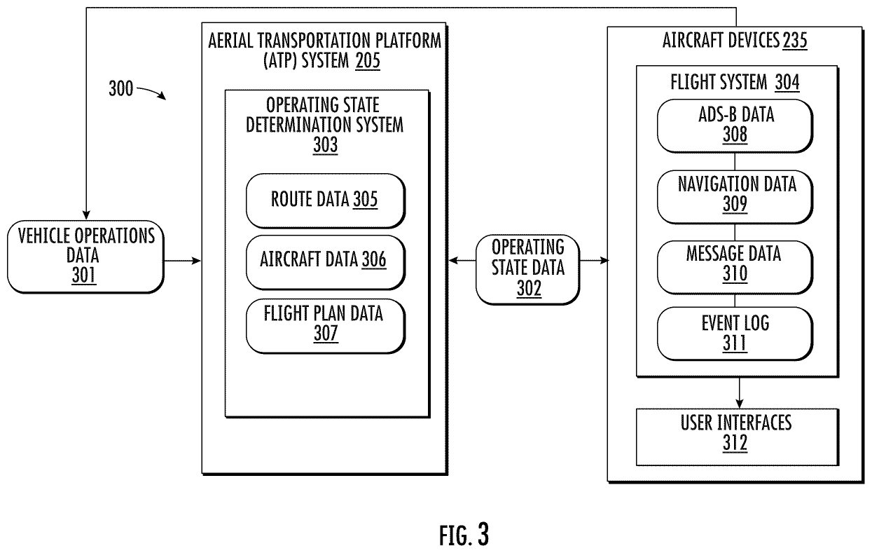

The ATP system 205 can detect and update operating states for aircraft assigned to perform a transportation service. For example, FIG. 3 depicts an example dataflow pipeline 300 for detecting and updating operating states for aircraft according to example implementations of the present disclosure.

The example dataflow pipeline 300 is described with an example implementation in which data is consumed by the operating state determination (OSD) system 303 running one or more servers of the ATP system 205 to compute, and update, operating states for aircraft. For instance, the OSD system 303 can ingest route data 305, aircraft data 306, flight plan data 307, ADS-B data 308, navigation data 309, and message data 310 to compute operating state data 302. The operating state data 302 can be provided to the aircraft devices 235 of an aircraft and other systems.

A flight system 304 of the aircraft can utilize ADS-B data 308 to determine a position and/or velocity of the aircraft, e.g., as the aircraft operates along a route. The flight system 304 can utilize the operating state 302 to update an event log 311, which can be presented via one or more user interfaces 312 to indicate flight start time, flight end time, and other performance parameters for the aircraft during completion of the route. The OSD system 303 can continue to ingest route data 305, aircraft data 306, flight plan data 307, ADS-B data 308, navigation data 309, and message data 310 from the fleet of aircraft and generate updated operating states 302, as needed.

The following will now describe the components of the example data pipeline 300 in greater detail.

The OSD system 303 can include software running on one or more servers within the ATP system 205. The OSD system 303 can be a sub-system of the ATP system 205 and utilize shared computing resources. While examples herein describe the OSD system 303 as a sub-system of the ATP system 205, the OSD system 303 may be a standalone system (e.g., within the computing ecosystem 200) or implemented within another system, such as within the aircraft device 235.

The OSD system 303 can be programmed to compute and update operating states for aircraft. With reference to FIG. 5, the operating states may include an off-block operating state OB, a takeoff operating state TO, a landing operating state LO, and an in-block operating state IB. The off-block operating state OB may correspond when an aircraft 400 moves from a parked position. For instance, the aircraft 400 may be loaded, ready for departure, and move away from a parking position towards a take-off position when the aircraft 400 is in the off-block operating state OB.

The takeoff operating state TO may correspond when the aircraft 400 leaves the ground. For instance, the aircraft 400 may power up and take flight when the aircraft 400 is in the takeoff operating state TO. The flight of the aircraft 400 may be thrust-borne or wing-borne as the aircraft 400 switches to the takeoff operating state TO. Moreover, the aircraft 400 may have a vertical takeoff or a conventional takeoff as the aircraft 400 switches to the takeoff operating state TO.

The landing operating state TL may correspond when the aircraft 400 touches down from a flight. For instance, the aircraft 400 may arrive at a destination location and land on a pad, strip, etc. when the aircraft 400 is in the landing operating state TL. The flight of the aircraft 400 may be thrust-borne or wing-borne as the aircraft 400 switches to the landing operating state TL. Moreover, the aircraft 400 may have a vertical landing or a conventional landing as the aircraft 400 switches to the landing operating state TL.

The in-block operating state IB may correspond when the aircraft 400 moves to a parked position. For instance, the aircraft 400 may taxi or be towed (e.g., by a vehicle, robotic device) to the parking position and stop moving when the aircraft 400 is in the in-block operating state IB. It will be understood that such list of operating states is not exclusive and that other operation states may also be detected by the OSD system 303.

The OSD system 303 can detect the current operating state for the aircraft, such as each aircraft of a fleet of aircraft, as the aircraft operates along a route. As further described herein, this can include computing the operating state of the aircraft at a determined frequency (such as every five seconds, ten seconds, thirty seconds, or another time interval) or in response to data inputs while the aircraft is in-operation.

The OSD system 303 can access various types of data to help perform the functions thereof. In some example implementations, accessing data can include performing look-up functions, API calls, queries, pulls, pushes, etc.

The OSD system 303 can access route data 305. Route data 305 can be stored in a simple or complex data structure within the OSD system 303 or another system. This can include storing the aircraft data 306 in a simple array and/or linked list.

More particularly, the OSD system 303 can perform a function that searches for a specific value or information within the array or other data structure (e.g., linked list, hash tables, binary search trees) that is populated with the route data 305. The OSD system 303 can utilize a search algorithm to efficiently locate the desired route data 305 within the data structure. The search parameters can include information associated with a particular aircraft such as an aircraft identifier.

The OSD system 303 can perform various search functions based on the underlying data structure. For example, for an array populated with the route data 305, the OSD system 303 can use a simple linear search or binary search. For a hash table, the OSD system 303 can use a hashing algorithm to compute the location of the desired route data 305 based on its key. For a binary search trees, the OSD system 303 can use a traversal algorithms (e.g., in-order, pre-order, post-order) to navigate the tree and find the desired node associated with the desired route data 305 for a given aircraft.

Route data 305 can include concatenated information associated with routes assigned to aircraft to facilitate a transportation service in a geographic area. A route can include a path for the aircraft from an origin to a destination. A route can be divided into a plurality of route segments. A route segment can include a portion of a route that is less than the entire route. For example, a ten mile route may be broken into five route segments, each approximately two miles. A route (and its route segments) may include a series of waypoints for an aircraft to follow. The route data 305 can indicate a route and can include information associating a particular aircraft or plurality of aircraft with a route and its route segments.

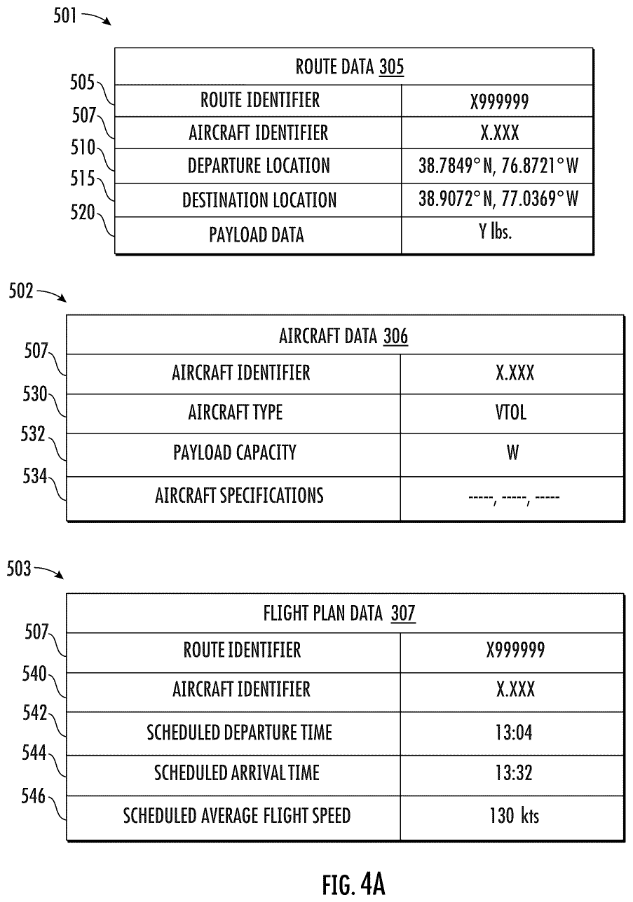

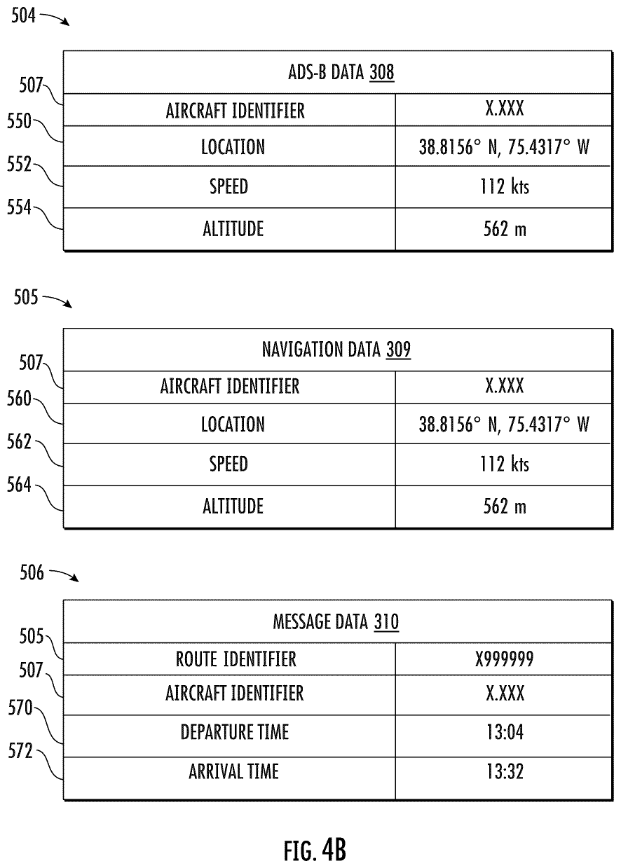

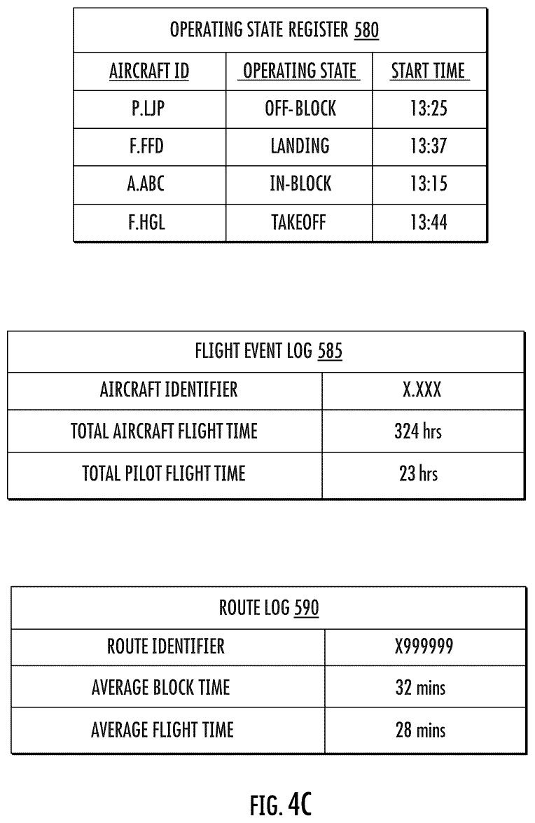

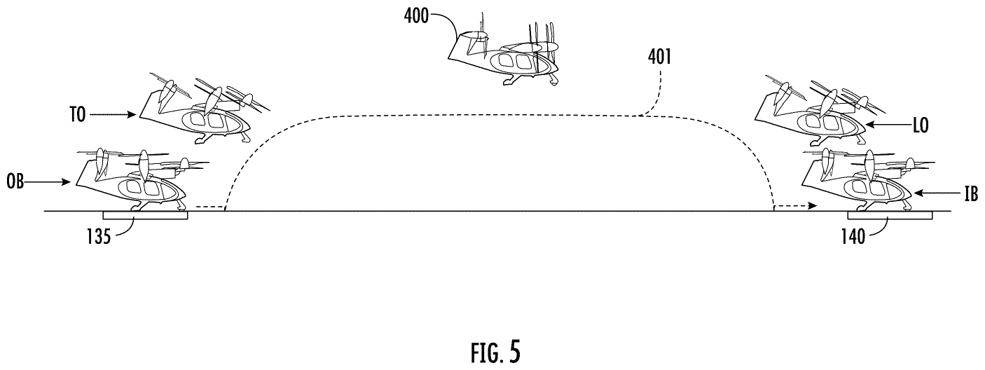

The route data 305 may include various types of information. FIG. 4A shows an example data structure 501 that includes route data 305. Data structure 501 can include a database table storing route data 305 for a geographic region. While examples herein illustrate the data structure 501 as database tables, the present disclosure is not limited to such embodiment. The data structure 501 can be any simple or complex data structure capable of organizing and concatenating data from multiple data sources.

Route data 305 can include information associated with routes assigned to a fleet of aircraft operating in a transportation service. For instance, route data 305 can include route identifier data 505 to identify particular routes assigned to an aircraft. The route identifier data 505 can include one or alphanumerical characters which identify a particular route.

Route data 305 can include or be associated with an aircraft identifier 507 that indicates the aircraft assigned to the associated route. For example, the aircraft data 306 can be concatenated with route identifier data 505 to generate the association. The aircraft identifier data 306 can include one or more alphanumerical characters which identify a particular aircraft in a fleet of aircraft. Once a route (e.g., route identifier 505) has been assigned to an aircraft, aircraft identifier data 306 can be concatenated with the route identifier data 505 along with route details.

The route data 305 can include certain flight itinerary information. For example, the route data 305 can include the departure location 510 and destination location 515 of the aircraft assigned to the route. This information can be expressed as coordinates, addresses, place names, etc. In some examples, the departure location 510 and destination location 515 can be intermediate locations within a multi-modal transportation service.

The route data 305 can include the locations of waypoints of the route. The waypoints can be expressed, for example, in latitudinal and longitudinal coordinates. The route data 305 can indicate the number of route segments and the location of those route segments and/or the waypoints associated therewith.

The route data 305 can include payload data 520 indicative of a payload assigned to travel on the aircraft. The payload data 520 can indicate a total weight of a payload, a number of passengers, a number of items, a type of cargo, etc.

While the example route data 305 depicts routing information for a single aircraft in a fleet of aircraft, a plurality of aircraft (e.g., aircraft identifier data 306) can also be concatenated with a single route identifier 505. For instance, a route can include a plurality of intermediate stops between an origin location and a destination location. As such, a plurality of aircraft can be used to transport passengers and/or cargo from the origin location to the destination location. For example, passengers and/or cargo can change aircraft at an intermediate location such as a vertiport prior to arrival at a destination location.

Returning to FIG. 3, the OSD system 303 can store or otherwise access aircraft data 306 indicating information specific to a particular aircraft. The aircraft data 306 can be stored within a data structure of the OSD system 303 or accessed from another system (e.g., aircraft device 235, etc.). The OSD system 303 can access the aircraft data by performing functions similar to those previously described herein for accessing route data 303.

FIG. 4A shows an example data structure 502 that includes aircraft data 306. While FIG. 5A shows data structure 502 as a database table storing aircraft data 306 other types of data structures can be used. The aircraft data 306 can include the aircraft identifier 507 associated with a particular aircraft. The aircraft data 306 can indicate an aircraft type 530 (e.g., VTOL, helicopter, CTOL, etc.). The aircraft data 306 can include payload capacity data 532 indicative of a payload capacity of the aircraft. The payload capacity data 532 can indicate a total weight of a payload, a number of passengers, a number of items, a type of cargo, etc. that the aircraft can carry during operation. The aircraft data 306 can indicate aircraft specifications 534 for an aircraft such as the aircraft's configuration, battery type and configuration, maximum altitude, flight range, performable landing maneuvers, average speed, etc.

In some implementations, the aircraft data 306 can include other information. For example, the aircraft data 306 can indicate one or more operators or providers of the aircraft. Additionally, or alternatively, the aircraft data 306 can indicate the location of the aircraft. This can include, for example, a location at which the aircraft is stored or where the aircraft is located prior to its first flight.

Once, the ATP system 205 determines an aircraft can perform the transportation service (e.g., based on the aircraft characteristics associated with the aircraft), route data 305 can be updated to indicate that an aircraft has been assigned to the route to transport the passengers from the departure location 510 to the destination location 515. The route data 305 can be updated to include the aircraft identifier 507 for the assigned aircraft and/or the aircraft data 306 can be updated to the route identifier 505 for the assigned route. For example, the OSD system 303 can concatenate the route data 305 and aircraft data 306 into a data structure such that the aircraft data 306 supplements the route data 305 with additional information of the specific aircraft or plurality of aircraft assigned to a route, or vice versa.

Returning to FIG. 3, to help compute the operating states for aircraft, the OSD system 303 can access flight plan data 307. The flight plan data 307 can indicate one or more scheduled departure and arrival times for the aircraft for the assigned route.

The flight plan data 307 can be stored in a simple or complex data structure within the OSD system 303 or another system. This can include storing the flight plan data 307 in a simple array and/or linked list. The OSD system 303 can access the flight plan data 307 by performing functions similar to those previously described herein for accessing route data 303.

Flight plan data 307 can include concatenated information associated with scheduled operations for the aircraft to facilitate a transportation service in a geographic area. The flight plan data 307 can indicate a scheduled departure time for a particular aircraft or plurality of aircraft to service a route and its route segments, and the flight plan data 307 can indicate a scheduled arrival time for the particular aircraft or plurality of aircraft to service the route and its route segments.

The flight plan data 307 may include various types of information. FIG. 4A shows an example data structure 503 that includes flight plan data 307. Data structure 503 can include a database table storing flight plan data 307 for an aircraft. While examples herein illustrate the data structure 503 as database tables, the present disclosure is not limited to such embodiment. The data structure 503 can be any simple or complex data structure capable of organizing and concatenating data from multiple data sources.

Flight plan data 307 can include information associated with routes and aircraft operating in a transportation service. For instance, flight plan data 307 can include the route identifier data 505 to identify particular routes assigned to an aircraft. As another example, the flight plan data 307 can include the aircraft identifier 507 for the aircraft assigned to the route. The aircraft data 306 can be concatenated with route identifier data 505 to generate the association.

The flight plan data 307 can include certain planned flight operation information. For example, the flight plan data 307 can include the scheduled departure time 542 and the scheduled arrival time 544 of the aircraft assigned to the route. In some examples, the scheduled departure time 542 can include two or more scheduled departure times, such as an initial scheduled departure time, one or more intermediate scheduled departure times, and/or a final scheduled departure time. In some examples, the scheduled arrival time 544 can include two or more scheduled arrival times, such as an initial scheduled arrival time, one or more intermediate scheduled arrival times, and/or a final scheduled arrival time. The flight plan data 307 can indicate scheduled departure times, scheduled arrival times, scheduled times and durations for traveling along a particular route segment, etc. Such information can be reflective of a schedule associated with an expected departure time and arrival time of the aircraft.

Returning to FIG. 3, the OSD system 303 can access the aircraft data by performing functions similar to those previously described herein for accessing route data 303. The OSD system 303 can access data from an aircraft to help compute the operating states for aircraft. For example, the OSD system 303 can access the aircraft data by performing functions similar to those previously described herein for accessing route data 305. The OSD system 303 can access one or more of ADS-B data 308, navigation data 309, and message data 310 to assist with computing the operating states for aircraft. Thus, the flight system 304 can transmit the ADS-B data 308, the navigation data 309, and/or the message data 310 to the OSD system 303.

In some example implementations, the flight system 304 can communicate with the OSD system 303 using an Application Programming Interface (API). For instance, the OSD system 303, the ATP system 205 (or the entity associated therewith) can be associated with an API that defines the methods, rules, protocols and tools that allows different aircraft (and their onboard computing systems) to interact with the OSD system 303. The API can expose specific endpoints or URLs that represent different functionalities or resources. Each endpoint can correspond to a particular operation or data resource. In some implementations, the OSD system 303 (e.g., being a service or sub-system of the ATP system 205) can correspond to an exposed endpoint.

In some example implementations, the API can include an authentication process. This authentication process may include sending credentials (such as API keys or tokens) along with a request.

The API can allow the flight system 304 and the OSD system 303 to communicate in a client-server type architecture. For example, communication between the systems through the API can follow a request-response cycle. The flight system 304 can transmit (over a network) a request to the OSD system 303 using the defined API endpoints. The request can contain information such as the desired parameters or any data required for the operation.

The request can be serialized into a format that can be transmitted and reconstructed on by the OSD system 303. This may include, for example, serialization formats such as JSON (JavaScript Object Notation) and XML (extensible Markup Language). The request (and response) messages may be transmitted over the network using a transport protocol such as HTTP (Hypertext Transfer Protocol) or HTTPS (HTTP Secure).

The OSD system 303 can receive the request from the flight system 304. The OSD system 303 can process the request based on the specified operation and parameters. This may involve accessing databases, performing calculations, or executing other tasks.

Once the OSD system 303 has processed the request, the OSD system 303 can send back a response to the flight system 304. This may include a confirmation that the data from the flight system 304 has been received. The response may include a status code indicating the success or failure of the request, along with any requested data or relevant information.

Various types of data may be transmitted to the OSD system 303 from the flight system 304 (e.g., via an API). For example, the ADS-B data 308 can indicate one or both of a position and velocity of the aircraft. The ADS-B data 308 can be determined via satellite navigation or onboard sensors of the aircraft. The ADS-B data 308 can be received via a datalink of an ADS-B system onboard the aircraft.

The ADS-B data 308 can be stored in a simple or complex data structure within the OSD system 303 or another system. This can include storing the ADS-B data 308 in a simple array and/or linked list. In example embodiments, the ADS-B data 308 can include concatenated information associated with measured positions and velocities of the aircraft from a high-integrity satellite navigation source, such as GPS or other certified GNSS receiver, of the ADS-B system onboard the aircraft.

The ADS-B data 308 may include various types of information. FIG. 4B shows an example data structure 504 that includes ADS-B data 308. Data structure 504 can include a database table storing flight plan data 307 for an aircraft. While examples herein illustrate the data structure 504 as database tables, the present disclosure is not limited to such embodiment. The data structure 504 can be any simple or complex data structure capable of organizing and concatenating data from multiple data sources.

ADS-B data 308 can include information associated with the position and velocity of the aircraft of aircraft operating in a transportation service. For instance, ADS-B data 308 can include the aircraft identifier 507 for the aircraft assigned to a route. For example, the ADS-B data 308 can include location data 550 of the aircraft assigned to the route. The location data 550 can be expressed as coordinates or with other units. The ADS-B data 308 can further include speed data 552 of the aircraft assigned to the route. The speed data 552 can be expressed as knots or in other units. The ADS-B data 308 can also include altitude data 554 of the aircraft assigned to the route. The altitude data 554 can be expressed as meters or in other units. The location data 550, speed data 552, and altitude data 554 can be concatenated with the aircraft identifier 507 to generate the association.

The ADS-B data 308 can include certain operating parameters for the aircraft. For example, the ADS-B data 308 can include the measured positions and velocities of the aircraft. The ADS-B data 308 can be compiled continuously or at a predetermined frequency.

It will be understood that, while described in the context of ADS-B data, telemetry data from other sources may be used (additionally or alternatively). For instance, data from a SWIM system, a HRR system, an LTE Cube system, a GPS, a WAAS, or another system may be used in addition to or as an alternative to the ADS-B data. The telemetry data from the other sources can include certain operating parameters for the aircraft, such as the measured positions and velocities of the aircraft.

The navigation data 309 can indicate one or both of a position and velocity of the aircraft. The navigation data 309 can be determined via satellite navigation, onboard sensors, or an avionics system of the aircraft.

The navigation data 309 can be stored in a simple or complex data structure within the OSD system 303 or another system. This can include storing the navigation data 309 in a simple array and/or linked list. In example embodiments, the navigation data 309 can include concatenated information associated with measured or estimated positions and velocities of the aircraft from a GPS or other certified GNSS receiver, an inertial navigation system, or other avionics systems onboard the aircraft.

The navigation data 309 may include various types of information. FIG. 4B shows an example data structure 505 that includes navigation data 309. Data structure 505 can include a database table storing navigation data 309 for an aircraft. While examples herein illustrate the data structure 505 as database tables, the present disclosure is not limited to such embodiment. The data structure 505 can be any simple or complex data structure capable of organizing and concatenating data from multiple data sources.

Navigation data 309 can include information associated with the position and velocity of the aircraft of aircraft operating in a transportation service. For instance, the navigation data 309 can include the aircraft identifier 507 for the aircraft assigned to a route. For example, the navigation data 309 can include location data 560 of the aircraft assigned to the route. The location data 560 can be expressed as coordinates or with other units. The navigation data 309 can further include speed data 562 of the aircraft assigned to the route. The speed data 562 can be expressed as knots or in other units. The navigation data 309 can also include altitude data 564 of the aircraft assigned to the route. The altitude data 564 can be expressed as meters or in other units. The location data 560, speed data 562, and altitude data 564 can be concatenated with the aircraft identifier 507 to generate the association.

The navigation data 309 can include certain operating parameters for the aircraft. For example, the navigation data 309 can include the measured positions and velocities of the aircraft. The navigation data 309 can be compiled continuously or at a predetermined frequency.

The message data 310 can indicate one or more pilot-generated departure and arrival times for the aircraft for the assigned route.

The message data 310 can be stored in a simple or complex data structure within the OSD system 303 or another system. This can include storing the message data 310 in a simple array and/or linked list.

The message data 310 can include concatenated information associated with operations for the aircraft to facilitate a transportation service in a geographic area. The message data 310 can indicate a pilot-generated departure time for a particular aircraft or plurality of aircraft to service a route and its route segments, and the message data 310 can indicate a pilot-generated arrival time for the particular aircraft or plurality of aircraft to service the route and its route segments. The pilot may use one or more user interfaces 312 onboard the aircraft to input the departure and arrival times for the message data 310.

The message data 310 may include various types of information. FIG. 4B shows an example data structure 506 that includes message data 310. Data structure 506 can include a database table storing message data 310 for an aircraft. While examples herein illustrate the data structure 506 as database tables, the present disclosure is not limited to such embodiment. The message data 310 can be any simple or complex data structure capable of organizing and concatenating data from multiple data sources.

Message data 310 can include information associated with routes and aircraft operating in a transportation service. For instance, message data 310 can include the route identifier data 505 to identify particular routes assigned to an aircraft. As another example, the message data 310 can include the aircraft identifier 507 for the aircraft assigned to the route. The aircraft data 306 can be concatenated with route identifier data 505 to generate the association.

The message data 310 can include certain pilot-generated flight operation information. For example, the message data 310 can include the departure time 570 and the arrival time 572 of the aircraft assigned to the route that are provided by the pilot during operation of the aircraft. In some examples, the departure time 570 can include two or more departure times, such as an initial departure time, one or more intermediate departure times, and/or a final departure time. In some examples, the arrival time 572 can include two or more arrival times, such as an initial arrival time, one or more intermediate arrival times, and/or a final arrival time. The message data 310 can indicate pilot generated information regarding departure times, arrival times, times and durations for traveling along a particular route segment, etc. Such information can be reflective of actual, pilot-confirmed operating information associated with a departure time and arrival time of the aircraft.

As noted above, the OSD system 303 can be programmed to compute and update operating states for aircraft, such as the off-block operating state OB, the takeoff operating state TO, the landing operating state LO, and the in-block operating state IB. Moreover, based upon one or more of the route data 305, the aircraft data 306, the flight plan data 307, the ADS-B data 308, the navigation data 309, and the message data 310, the ATP system 205 (or another system) can compute the operating states for aircraft.

In example embodiments, the ATP system 205 (or another system) can compute the operating states for aircraft based on all of the route data 305, the aircraft data 306, the flight plan data 307, the ADS-B data 308, the navigation data 309, and the message data 310. However, during operation of the aircraft, one or more of the ADS-B data 308, the navigation data 309, and the message data 310 may be unavailable. For instance, signal communication with the aircraft may be lost or interrupted such that the ADS-B data 308, the navigation data 309, and the message data 310 is not available in real-time or only outdated data is available. In contrast, the route data 305, the aircraft data 306, and the flight plan data 307 are generally available locally on the OSD system 303. For instance, the route data 305, the aircraft data 306, and the flight plan data 307 may generally correspond to data for the aircraft servicing a route that do not vary during operation. Thus, the route data 305, the aircraft data 306, and the flight plan data 307 may correspond to parameters of the aircraft that are predetermined prior to departure.

When the ADS-B data 308, the navigation data 309, and the message data 310 are unavailable, the OSD system 303 can compute the operating state for the aircraft based on the route data 305, the aircraft data 306, and the flight plan data 307. For instance, the OSD system 303 can compute that the aircraft is in one of the off-block operating state OB, the takeoff operating state TO, the landing operating state LO, and the in-block operating state IB based on the route data 305, the aircraft data 306, and the flight plan data 307.

In example embodiments, the OSD system 303 can compute that the aircraft is in the off-block operating state OB when a current time corresponds to a scheduled departure time. Thus, e.g., the OSD system 303 can determine that the aircraft is moving from a parked position when the current time corresponds to the scheduled departure time 542 from the flight plan data 307. The OSD system 303 can compute that the aircraft is in the takeoff operating state TO when the current time corresponds to a sum of the scheduled departure time and a takeoff offset value. The takeoff offset value may correspond to an average taxi time for the aircraft from the parked position to takeoff. For example, the takeoff offset value may be about five minutes, about six minutes, about ten minutes, or another time value. Thus, e.g., the OSD system 303 can determine that the aircraft leaves the ground when the current time corresponds to the sum of the scheduled departure time 542 from the flight plan data 307 and the takeoff offset value.

The OSD system 303 can compute that the aircraft is in the landing operating state LO when the current time corresponds to a difference between a scheduled arrival time and a landing offset value. The landing offset value may correspond to an average taxi time for the aircraft from landing to the parked position. For example, the landing offset value may be about five minutes, about six minutes, about ten minutes, about fifteen minutes, or another time value. Thus, e.g., the OSD system 303 can determine that the aircraft lands when the current time corresponds to the difference of the scheduled departure time 542 from the flight plan data 307 and the landing offset value. The OSD system 303 can compute that the aircraft is in the in-block operating state IB when the current time corresponds to the scheduled arrival time. Thus, e.g., the OSD system 303 can determine that the aircraft is in the parked position when the current time corresponds to the scheduled arrival time 544 from the flight plan data 307.

In example embodiments, the OSD system 303 can compute that the aircraft is in the landing operating state LO when the current time corresponds to a sum of the scheduled departure time 542 and an average flight time for the aircraft. The average flight time may correspond to a distance between an origin location and a destination location divided by an average speed of the aircraft. The distance between an origin location and a destination location may be computed as a product of a haversine distance between the departure location 510 and the destination location 515 from the route data 305 and a safety margin, such as value of one and two-tenths, one and three-tenths, one and four-tenths, or another value. The product of the haversine distance and the safety margin may be divided by the average speed of the aircraft, which may be part of the aircraft specifications 534 of the aircraft data 306, to calculate the average flight time for the aircraft.

As may be seen from the above, the OSD system 303 may proceed as if the aircraft is operating on schedule when other data sources are unavailable.

When one or more of the ADS-B data 308 and/or the navigation data 309 are available, the OSD system 303 can compute the operating state for the aircraft based on the ADS-B data 308 and/or the navigation data 309. For instance, the OSD system 303 can compute that the aircraft is in one of the off-block operating state OB, the takeoff operating state TO, the landing operating state LO, and the in-block operating state IB based on the ADS-B data 308 and the navigation data 309. It will be understood that the OSD system 303 can compute the off-block operating state OB, the takeoff operating state TO, the landing operating state LO, and the in-block operating state IB in sequence, e.g., such that the off-block operating state OB, the takeoff operating state TO, the landing operating state LO, and the in-block operating state IB are each detected sequentially during operation. Thus, e.g., the OSD system 303 may only compute the takeoff operating state TO when the current detected operating state is the off-block operating state OB. Similarly, the OSD system 303 may only compute the landing operating state LO when the current detected operating state is the takeoff operating state TO. Further, the OSD system 303 may only compute the in-block operating state IB when the current detected operating state is the landing operating state LO.

In example embodiments, the OSD system 303 can compute that the aircraft is in the off-block operating state OB when two or more consecutive velocity measurements are greater than an off-block speed value. Thus, e.g., the OSD system 303 can determine that the aircraft is moving from the parked position when two or more consecutive velocities in the speed data 552 of the ADS-B data 308 and/or in the speed data 562 of the navigation data 309 are greater than the off-block speed value. The off-block speed value may correspond to a significant speed indicative of the aircraft moving out of the parked position, such as no less than three knots, no less than four knots, no less than five knots, or other values.

The OSD system 303 can also compute (additionally or alternatively) that the aircraft is in the off-block operating state OB when two or more consecutive velocity measurements are increasing. Thus, e.g., the OSD system 303 can determine that the aircraft is moving from a parked position when two or more consecutive velocities in the speed data 552 of the ADS-B data 308 and/or in the speed data 562 of the navigation data 309 are increasing. The OSD system 303 can also compute (additionally or alternatively) that the aircraft is in the off-block operating state OB when a velocity measurement is greater than an off-block speed threshold value. Thus, e.g., the OSD system 303 can determine that the aircraft is moving from the parked position when the velocity in the speed data 552 of the ADS-B data 308 and/or in the speed data 562 of the navigation data 309 is greater than the off-block speed threshold. The off-block speed threshold may correspond to a significant speed indicative that the aircraft is moving and not in the parked position, such as no less than ten knots, no less than twenty knots, no less than thirty knots, or other values.

In example embodiments, the OSD system 303 can compute that the aircraft is in the takeoff operating state TO when a velocity measurement is greater than a takeoff speed value and an altitude measurement is greater than a takeoff altitude value. Thus, e.g., the OSD system 303 can determine that the aircraft leaves the ground when the velocity in the speed data 552 of the ADS-B data 308 and/or in the speed data 562 of the navigation data 309 is greater than the takeoff speed value and the altitude data 554 of the ADS-B data 308 and/or in the altitude data 564 of the navigation data 309 is greater than the takeoff altitude value. The takeoff speed value may correspond to a significant speed indicative of the aircraft taking flight, such as no less than twenty knots, no less than thirty knots, or other values. The takeoff altitude value may correspond to a significant altitude indicative of the aircraft taking flight, such as no less than zero, no less than two meters, no less than ten meters, or other values. The OSD system 303 can also compute (additionally or alternatively) that the aircraft is in the takeoff operating state TO when the velocity measurement is greater than a takeoff speed threshold and a variometer rate measurement is greater than a takeoff rate threshold. Thus, e.g., the OSD system 303 can determine that the aircraft leaves the ground when the velocity in the speed data 552 of the ADS-B data 308 and/or in the speed data 562 of the navigation data 309 is greater than the takeoff speed threshold and the altitude data 554 of the ADS-B data 308 and/or in the altitude data 564 of the navigation data 309 include the variometer rate measurement greater than the takeoff rate threshold. The takeoff speed threshold may correspond to a significant speed indicative of the aircraft taking flight, such as no less than forty knots, no less than fifty knots, no less than sixty knots, or other values. The takeoff rate threshold may correspond to a rate of climb rate indicative of the aircraft taking flight, such as no less than a meter per second or other values.

In example embodiments, the OSD system 303 can compute that the aircraft is in the landing operating state LO when an altitude measurement is less than a landing altitude value and a position measurement is less than a landing position value from a destination location. Thus, e.g., the OSD system 303 can determine that the aircraft lands on the ground when the altitude data 554 of the ADS-B data 308 and/or in the altitude data 564 of the navigation data 309 is less than the landing altitude value and the location data 550 of the ADS-B data 308 and/or in the location data 560 of the navigation data 309 is less than the landing position value from the destination location 515 from the route data 305. The takeoff altitude value may correspond to an altitude indicative of the aircraft landing, such as no greater than one meter, about zero, or other values. The landing position value may correspond to a distance indicative of the aircraft arriving at the destination, such as no greater than one hundred meters, no greater than fifty meters, or other values. The OSD system 303 can also compute (additionally or alternatively) that the aircraft is in the landing operating state LO when a velocity measurement is less than a landing speed threshold. Thus, e.g., the OSD system 303 can determine that the aircraft lands on the ground when the velocity in the speed data 552 of the ADS-B data 308 and/or in the speed data 562 of the navigation data 309 is less than the landing speed threshold. The landing speed threshold may correspond to a significant speed indicative of the aircraft landing, such as no greater than forty knots, no greater than thirty knots, or other values.

In example embodiments, the OSD system 303 can compute that the aircraft is in the in-block operating state IB when two or more consecutive velocity measurements are less than an in-block speed value. Thus, e.g., the OSD system 303 can determine that the aircraft is moving into the parked position when two or more consecutive velocities in the speed data 552 of the ADS-B data 308 and/or in the speed data 562 of the navigation data 309 are less than the in-block speed value. The in-block speed value may correspond to a speed indicative of the aircraft in the parked position, such as no greater than six knots, no greater than five knots, no greater than four knots, or other values. The OSD system 303 can also compute (additionally or alternatively) that the aircraft is in the in-block operating state IB when the ADS-B data 308 and/or the navigation data 309 are no longer available, which can indicate that the aircraft is powered down in the parked position.

As may be seen from the above, the OSD system 303 may compute the operating states for the aircraft based upon operating data, such as velocity and position, when available.

The pilot of the aircraft may also correspond to a source of truth for the OSD system 303 regarding the current operating state of the aircraft. For example, the pilot may use one or more user interfaces 312 onboard the aircraft to input the departure and arrival times for message data. The OSD system 303 may use the departure and arrival times of the message data to compute the off-block operating state OB and the in-block operating state IB. Moreover, the departure time 570 from the message data 310 may be taken by the OSD system 303 to correspond to the off-block operating state OB, and the arrival time 572 from the message data 310 may be taken by the OSD system 303 to correspond to the in-block operating state IB. The OSD system 303 may not override the pilot generated departure and arrival times to generate the operating states for the aircraft, e.g., using one or more of the route data 305, the aircraft data 306, the flight plan data 307, the ADS-B data 308, and the navigation data 309.

As may be seen from the above, the OSD system 303 may compute the operating states for the aircraft based upon pilot generated data, such as an arrival time and departure time, when available.

With reference to FIG. 4C, the OSD system 303 may build an operating state register 580 for tracking the operating states of aircraft. The operating state register 580 can be associated with a unique or distinct operating state identifier for a particular aircraft providing at least one leg of a transportation service. The operating state register 580 can assemble a selection of participating aircraft from OSD system 303. Operating state register 580 can include at least one aircraft. For instance, the operating state register 580 may include all participating aircraft in a fleet of aircraft.

The operating state register 580 may include the operating state for the aircraft. In this manner, the operating state register 580 can accurately reflect, in real-time, the operating state for aircraft of the ecosystem 200 that are associated with each particular service instance for the users of the transportation service. Thus, e.g., the operating state register 580 can indicate the latest one of the off-block operating state OB, the takeoff operating state TO, the landing operating state LO, and the in-block operating state IB (or another operating state) for each aircraft of the ecosystem 200.

The ATP system 205 (or another system) can also update and reconfigure operating state data 302 as needed with the current operating state for a particular aircraft, which can assist with accommodating for scheduling changes, delays, aircraft substitution, etc. or as the operating state data 302 may be used to update and reconfigure the operating state register 580. For example, as the aircraft or user progresses along a leg of a particular journey, the ATP system 205 may identify operating states for the aircraft during the route (as further described herein) and update the operating state register 580 to include the operating state for the aircraft. The operating state data 302 may be computed in real-time by the ATP system 205 (or another system) based upon available data for the aircraft. For instance, each operating state may be detected within two minutes of the actual operating state start time.

The detected operating state for the aircraft can be used for a variety of advantageous uses. For instance, the data operating state data 302 may be used to calculate a total aircraft flight time of the aircraft. The total aircraft flight time may be calculated as a sum of a prior total aircraft flight time and a difference between a start time for the takeoff operating state TO and the landing operating state LO for the route. Thus, e.g., the total aircraft flight time of the aircraft may correspond to the total time that the aircraft is airborne across various routes. The total aircraft flight time may be tracked over an entire lifetime of the aircraft, between maintenance intervals, or other durations. As shown in FIG. 4C, the total aircraft flight time may be stored within a flight event log 585 or in another data structure. The total aircraft flight time may be updated after each instance of the route.

As another example, the data operating state data 302 may be used to calculate a total pilot flight time. The total pilot flight time may be calculated as a sum of a prior pilot aircraft flight time and a difference between a start time for the takeoff operating state TO and the landing operating state LO for the route. Thus, e.g., the total pilot flight time may correspond to the total time that the pilot flies the aircraft across various routes. The total pilot flight time may be tracked over an entire flight history of the pilot, between tracking intervals, or other durations. As shown in FIG. 4C, the total pilot flight time may be stored within the flight event log 585 or in another data structure. The total pilot flight time may be updated after each instance of the route.

The detected operating state for the aircraft can also be used (additionally or alternatively) for other advantageous uses. For instance, the data operating state data 302 may be used to calculate an average block time for a route of the aircraft. The average block time for the route may be calculated as a difference between a start time for a prior in-block operating state IB (e.g., from when the aircraft completed a prior route) and a start time for a subsequent off-block operating state OB (e.g., from when the aircraft takes off again to start a next route). Thus, e.g., the average block time may correspond to a downtime for the aircraft prior to beginning a route. As shown in FIG. 4C, the average block time may be stored within a route log 590 or in another data structure. The average block time may be updated after each instance of the route.

As another example, the data operating state data 302 may be used to calculate an average flight time for a route of the aircraft. The average flight time for the route may be calculated as a difference between a start time for the takeoff operating state TO and the landing operating state LO for the route. Thus, e.g., the average flight time may correspond to an average time that the aircraft is airborne during a route. As shown in FIG. 4C, the average flight time may be stored within the route log 590 or in another data structure. The average flight time may be updated after each instance of the route.

The ATP system 205 (or another system) can utilize the detected operating states and/or the values derived therefrom to generate updated flight plans for aircraft. For instance, the ATP system 205 (or another system) can utilize the average block time or the average flight time to update the subsequent flight plans for aircraft. Moreover, the scheduled departure time 542 and/or the scheduled arrival time 544 of the aircraft on future routes may be updated based upon the average block time and/or the average flight time to reflect the latest performance data for the aircraft.

As another example, the data operating state data 302 may be used to detect aircraft diversions. For instance, when the landing operating state LO and/or the in-block operating state IB is detected, the ATP system 205 (or another system) may also determine the position of the aircraft, such as via the telemetry system of the aircraft. If the current position of the aircraft does not match the destination of the aircraft, such as the destination location 515 from the route data 305, a diversion of the aircraft to another location can be detected and reported to an operator of the aircraft, e.g., to assist with contingency planning. Moreover, the flight plan for the aircraft may be updated based on the diversion. Thus, detecting the operating states for the aircraft can also assist with detecting diversions of aircraft from the intended destination. Such diversion detection can be particularly useful during short trips, e.g., when the pilot is busy with aircraft operations related to the diversion.

As another example, the data operating state data 302 may be used to detect touch-and-goes. For instance, when the pilot is practicing landings, the ATP system 205 (or another system) may detect the landing operating state LO and the takeoff operating state TO each time that the pilot performs a touch-and-go with the aircraft. The time of each landing operating state LO and each subsequent takeoff operating state TO may be logged to assist with record keeping for the pilot. Thus, detecting the operating states for the aircraft can also assist with tracking aircraft maneuvers during training.

The example dataflow pipeline 300, such as the ATP system 205 (or another system), can allow aircraft operators to focus on more discrete tasks while operating the aircraft, help improve real-time control decisions, while minimizing the effects of changes in flight operations of the overall transportation operations. Moreover, the example dataflow pipeline 300, such as the ATP system 205 (or another system), can increase computational efficiencies for both a network system and onboard the aircraft, while also increasing coordination among the fleet and reducing pilot burden when performing a transportation service.

### Example Computer-Implemented Processes and Methods

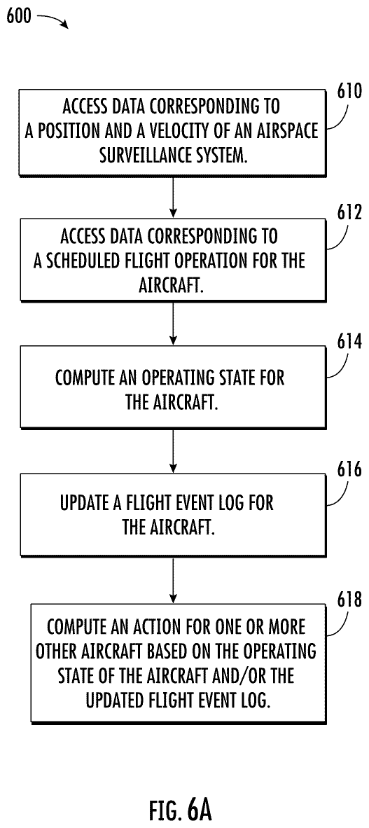

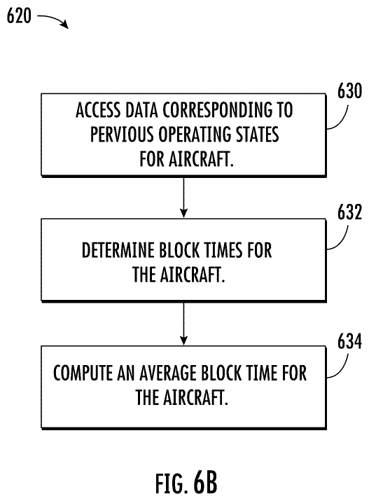

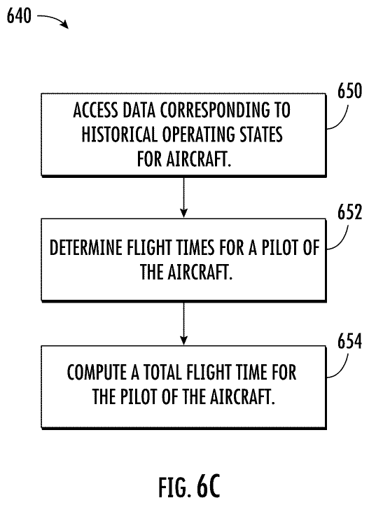

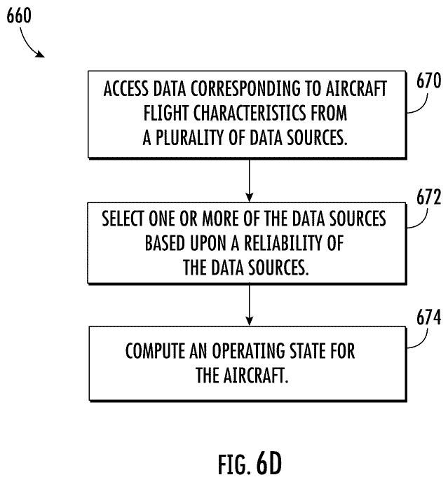

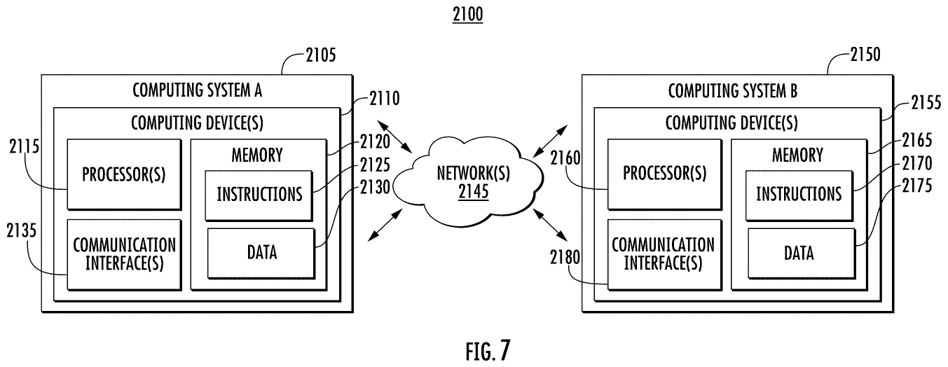

FIGS. 6A-D depict flowchart diagrams of example computer-implemented methods according to example embodiments of the present disclosure. The methods can be performed by a computing system that includes one or more computing devices such as, for example, the computing systems described with reference to the other figures herein. Each respective portion of the methods can be performed by any (or any combination) of one or more computing devices. Moreover, one or more portions of these methods can be implemented as one or more algorithms on the hardware components of the devices described herein to perform the functions described herein with respect to computing and assigning aircraft operating conditions.

FIG. 6 depict elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

FIG. 6 are described with reference to elements/terms described with respect to other systems and figures for exemplary illustrated purposes and is not meant to be limiting. One or more portions of the methods can be performed additionally, or alternatively, by other systems.

FIG. 6A is a flowchart diagram of an example computer-implemented method 1300 for determining an operating state of an aircraft according to example embodiments of the present disclosure.

At 610, the method 600 can include accessing data corresponding to a position and a velocity of a telemetry system for an aircraft. The telemetry system can correspond to a system that outputs telemetry data associated with the aircraft. For instance, the telemetry system may include one or more of a SWIM system, an avionic system of the aircraft, a HRR system, an ADS-B system, an LTE Cube system, a GPS, a WAAS, etc. Thus, at 610, the position and the velocity of the aircraft may be accessed via the data from the telemetry system. The telemetry system may be located onboard or offboard the aircraft. A computing system (e.g., an operating state determination system) can access the data corresponding to the position and the velocity of the telemetry system for the aircraft at 610, for example, using a look-up function or via an API as described herein.

At 612, the method 600 may include accessing data corresponding to a scheduled flight operation for the aircraft. The data corresponding to the scheduled flight operation for the aircraft may include one or both of a scheduled time of departure and a scheduled time of arrival for the aircraft. The data corresponding to the scheduled flight operation can also indicate scheduled times and durations for the aircraft traveling along a particular route segment. Thus, a schedule associated with an expected departure time and arrival time of the aircraft may be accessed at 612. The data corresponding to the scheduled flight operation may be stored locally on onboard the aircraft, e.g., after the pilot enters or confirms the scheduled flight operation. As another example, the data corresponding to the scheduled flight operation may be stored remotely offboard the aircraft, e.g., after an operator assigns the schedule to the pilot and/or aircraft. The computing system (e.g., the operating state determination system) can access the data corresponding to the scheduled flight operation for the aircraft at 612, for example, using a look-up function or via an API as described herein.

At 614, the method 600 may include computing an operating state for the aircraft. The operating state for the aircraft may be computed based on one or both of the data corresponding to the position and the velocity of the telemetry system for the aircraft and the data corresponding to the scheduled flight operation for the aircraft. The operating state may be computed no greater than two minutes from an actual operating state time.

The operating state may include one of an off-block operating state, a takeoff operating state, a landing operating state, and an in-block operating state. The off-block operating state may correspond to when the aircraft initially moves from a parked position. The takeoff operating state may correspond to when the aircraft takes flight and may directly follow the off-block operating state. The landing operating state may correspond to when the aircraft lands and may directly follow the takeoff operating state. The in-block operating state may correspond to when the aircraft moves into the parked position and may directly follow the landing operating state. The operating state sequence may be repeated for each route completed by the aircraft.

At 614, the computing system (e.g., the operating state determination system) can compute the off-block operating state when the data corresponding to the position and the velocity of the telemetry system for the aircraft and/or the data corresponding to the scheduled flight operation for the aircraft indicates that the aircraft is moving or is scheduled to move. At 614, the computing system (e.g., the operating state determination system) can compute the takeoff operating state when the data corresponding to the position and the velocity of the telemetry system for the aircraft and/or the data corresponding to the scheduled flight operation for the aircraft indicates that the aircraft takes flight or is scheduled to take flight. At 614, the computing system (e.g., the operating state determination system) can compute the landing operating state when the data corresponding to the position and the velocity of the telemetry system for the aircraft and/or the data corresponding to the scheduled flight operation for the aircraft indicates that the aircraft lands or is scheduled to land. At 614, the computing system (e.g., the operating state determination system) can compute the in-block operating state when the data corresponding to the position and the velocity of the telemetry system for the aircraft and/or the data corresponding to the scheduled flight operation for the aircraft indicates that the aircraft is stops moving or is scheduled to stop moving. Reference is made to the description of the operating state detection described above.

Each operating state may be detected no greater than two minutes of a respective actual operating state time. Thus, e.g., the method may detect the off-block operating state no greater than two minutes from when the aircraft initially moves from the parked position. The other operating states may be detected no greater than two minutes from the corresponding events.

At 616, the method 600 may include computing an updated flight event log for the aircraft based on the operating state for the aircraft. The updated flight event log may include the detected operating states for the aircraft during completion of a route as well as the time of detection for the operating state. The operating states in the updated flight event log may be used for various purposes, such as generating updated flight plans for the aircraft, computing an average block time, computing an average flight time, computing total flight time, computing total pilot time, etc.

The computing system (e.g., the operating state determination system) can compute the updated flight event log, at 616, using various types of computing functions. For example, the computing system can delete the data entries in one or more fields, cells, etc. and perform a write function to replace the data entry with a new data entry that reflects the computed operation state. In some example implementations, the computing system may perform a function to add a new data field, row, column, etc. to reflect the updated/current operation state or remove a data field, row, column, etc. to delete the previous/outdated operation state.

In some example implementations, the method 600 may also include adjusting the flight event log for the aircraft based on an override input by a pilot of the aircraft. Thus, the pilot can be a source of truth for the operating states of the aircraft. For example, the pilot may use a user interface onboard the aircraft to input departure and arrival times for the aircraft on a route. The method may use the departure and arrival times input by the pilot to compute the operating state for the aircraft, e.g., rather than the detected or scheduled departure and arrival times. For instance, the method 600 may associate the departure time input by the pilot as the off-block operating state for the aircraft and/or may associate the arrival time input by the pilot as the in-block operating state for the aircraft. The method 600 may not override the pilot generated departure and arrival times to generate the operating states for the aircraft, e.g., using one or more of route data, aircraft data, flight plan data, ADS-B data, and navigation data.

FIG. 6B is a flowchart diagram of an example computer-implemented method 620 for determining an operating state of an aircraft according to example embodiments of the present disclosure.

At 630, the method may include accessing data corresponding to previous operating states for aircraft. The previous operating states may be computed as described above during previously performed routes of the aircraft(s) performing a route. The computing system (e.g., the operating state determination system) can access the data corresponding to the previous operating states for the aircraft at 630.

At 632, the method may include determining block times for the aircraft. The block time for the aircraft may correspond to a downtime for the aircraft between routes, such as the difference between a start time for a prior in-block operating state when the aircraft completes the prior route and a start time for a subsequent off-block operating state when the aircraft starts the next route. The computing system (e.g., the operating state determination system) can determine block times for the aircraft at 632.

At 634, the method may include computing an average block time for the aircraft. The average block time for the aircraft may correspond to the average downtime for the aircraft between routes. The computing system (e.g., the operating state determination system) can calculate the average block time for the aircraft at 634. The method 620 may be used on an aircraft-by-aircraft basis, a route-by-route basis, or another basis to compute average block times in example embodiments.

The average block may be used to update subsequent flight plans for aircraft. For instance, the method 600 may include adjusting a scheduled departure time and/or a scheduled arrival time of the aircraft on future routes based upon the average block time. Thus, the future routes may more accurately reflect the downtime between routes.

The computing system (e.g., the operating state determination system) can compute the updated flight plans using various types of computing functions. For example, the computing system can delete the data entries in one or more fields, cells, etc. and perform a write function to replace it with a new data entry that reflects the updated flight plan. In some implementations, the computing system may perform a function to add a new data field, row, column, etc. to reflect the updated/current flight plan or remove a data field, row, column, etc. to delete the previous/outdated flight plan.

FIG. 6C is a flowchart diagram of an example computer-implemented method 640 for determining an operating state of an aircraft according to example embodiments of the present disclosure.

At 650, the method may include accessing data corresponding to previous operating states for aircraft. The previous operating states may be computed as described above during previously performed routes of the aircraft(s) performing a route. The computing system (e.g., the operating state determination system) can access the data corresponding to the previous operating states for the aircraft at 650 via a look-up function, API call, push, pull, etc., as described herein.

At 652, the method may include determining flight times for pilot(s) of the aircraft. The flight times for the pilots may correspond to time that the pilots fly the aircraft, such as during completion of routes. As an example, the flight times for the pilots may be calculated as a difference between a start time for the takeoff operating state and the landing operating state for each route. The computing system (e.g., the operating state determination system) can determine the flight times for the aircraft at 652.

At 654, the method may include computing a total flight time for the pilot. The total flight time for the pilot may correspond to the sum total of the flight times for the pilot flying the aircraft during completion of routes. The computing system (e.g., the operating state determination system) can calculate the total flight time for the pilot at 654. The method 640 may be used on an aircraft-by-aircraft basis, a route-by-route basis, or another basis to compute total flight times in example embodiments.

The total flight time may be used to track pilot regulatory compliance to avoid exceeding hour limits for pilot time. For instance, the method 600 may include adjusting a scheduled pilot workload for future routes to avoid exceeding regulatory limits for the total flight time. In example embodiments, the method 600 may include shifting the pilot off a route (e.g., and onto a shorter route) if the pilot is approaching a workload limit. In example embodiments, the method 600 may include shifting the pilot onto a route (e.g., and off a shorter route) if the pilot is within the workload limit. Thus, the scheduled aircraft operations may be piloted by pilots within regulatory limits.

FIG. 6D is a flowchart diagram of an example computer-implemented method 660 for determining an operating state of an aircraft according to example embodiments of the present disclosure.

At 670, the method 660 can include accessing data corresponding to aircraft flight characteristics from a plurality of data sources. For example, as described above, the method 660 may include accessing data corresponding to a position and a velocity of a telemetry system for an aircraft and/or data corresponding to a scheduled flight operation for the aircraft at 670. The computing system (e.g., the operating state determination system) can access the data corresponding to the scheduled flight operation for the aircraft and/or data corresponding to the position and the velocity of the telemetry system via a look-up function, API call, push, pull, etc., as described herein.

At 672, the method 660 may select one or more of the plurality of data sources based upon a reliability of the data sources. For instance, a pilot of the aircraft may correspond to a source of truth with the highest reliability. Thus, data from the pilot may be preferred or weighted over other data sources. As another example, telemetry data, such as from one or more of a SWIM system, an avionic system of the aircraft, a HRR system, an ADS-B system, an LTE Cube system, a GPS, a WAAS, etc., may have an intermediate reliability. Thus, data from the telemetry systems may be preferred or weighted over other data sources but less than pilot generated data. As another example, scheduled flight operation data may have a lowest reliability. Thus, data from the flight operation schedule may be least preferred or weighted over other data sources.

At 674, the method 660 may include computing an operating state for the aircraft based on the one or more selected data sources. The operating states may be computed as described above based upon the available reliable data. The computing system (e.g., the operating state determination system) can compute the operating state for the aircraft at 674.

Returning to FIG. 6A, at 618, the method 600 may include computing an action for one or more other aircraft based on the operating state of the aircraft and/or the updated flight event log for the aircraft. For instance, the computing system may include or be associated with a system for planning and managing a fleet of aircraft. This can include, for example, a fleet of aircraft for providing on-demand aerial transportation services within a dense, urban environment. The transportation services may be provided as an aerial leg, within a multi-model transportation system.

A user of the multi-model transportation system may have an ultimate ETA by which the user is to arrive at a destination. This can include estimate time for arrival after the user has been transported from: (i) an origin to a first aerial facility via ground transportation, (ii) the first aerial facility to a second aerial facility via an aircraft, and (iii) from the second aerial facility to the destination via another ground transportation.

Based on the determined operating state of the aircraft or the updated flight event lob, the computing system can compute actions for other aircraft in the fleet to undertake with respect to the service. For example, the computing system can process the updated flight event log to determine that a first aircraft is in an operation state that mis-aligns with an original flight schedule for the aircraft. The computing system can do so by querying a database that stores the original flight schedule for the aircraft. The original flight plan can, for example, be expressed as a table that indicates the various estimated events/states for an aircraft as well as associated times. The computing system can determine that, given its current operating state, the first aircraft is delayed.

The computing system can determine whether the first aircraft's delay is greater than a threshold amount, such that downstream flights/users would be significantly impacted. A user may be considered to be significantly impacted if, for example, the delay would cause the user to arrive later than their ETA at their ultimate destination. This computation may include the computing system calling an API to determine the estimated wait time, travel time, etc. associated with ground-based transportation from the landing location to the destination. Such information can allow the computing system to determine if an adjustment or expedition of the final ground leg in the multi-modal journey can compensate for the aircraft's delay.

If the delay may significantly impact a passenger, the computing system can compute an updated action for a second aircraft. This can include the second aircraft being assigned to a future flight or to transport the impacted user, which were previously assigned to the delayed aircraft. These assignments can be implemented by writing new data entries into the data fields that define the various flight plans/schedules and manifests of the second aircraft, and transmitting updated information (including route information) to the second aircraft. The computing system can transmit data indicative of the updated flight assignment and its associated route for implementation by the aircraft/pilot.

The user can be transported by the second aircraft in a manner that avoids violation of the user's ETA. This can include the second aircraft taking off at a time that is earlier than what would have been accomplished by the delayed first aircraft.

### Example Computing System Components

FIG. 14 depicts example system components of an example system 2100 according to example implementations of the present disclosure. The example system 2100 can include a computing system 2105 and a computing system 2150 that are communicatively coupled over one or more networks 2145. The computing systems 2105 and 2150 can represent, for example, computing systems that are onboard or offboard an aircraft, a cloud computing system, user computing system, or other systems/devices described herein.

The computing system 2105 can include one or more computing devices 2110. The computing devices 2110 of the computing system 2105 can include one or more processors 2115 and a memory 2120. The processors 2115 can be any suitable processing device (e.g., a processor core, a microprocessor, an ASIC, a FPGA, a controller, a microcontroller, etc.) and can be one processor or a plurality of processors that are operatively connected. The memory 2120 can include one or more non-transitory computer-readable storage media, such as RAM, ROM, EEPROM, EPROM, one or more memory devices, flash memory devices, etc., and combinations thereof.

The memory 2120 can store information that can be accessed by the processors 2115. For instance, the memory 2120 (e.g., one or more non-transitory computer-readable storage mediums, memory devices) can include computer-readable instructions 2125 that can be executed by the processors 2115. The instructions 2125 can be software written in any suitable programming language or can be implemented in hardware. Additionally, or alternatively, the instructions 2125 can be executed in logically and/or virtually separate threads on processors 2115.

For example, the memory 2120 can store instructions 2125 that when executed by the processors 2115 cause the processors 2115 to perform operations such as any of the processes/methods described herein or any of the operations and functions of any of the computing systems (e.g., aerial transportation platform system, ground transportation platform system, third party provider system, airspace system, etc.) and/or computing devices (e.g., user devices, ground vehicle devices, aircraft devices, aerial facility devices facility operator user devices, computing device 1500, etc.), as described herein.

The memory 2120 can store data 2130 that can be obtained, received, accessed, written, manipulated, created, and/or stored. The data 2130 can include, for instance, any of the data/information described herein. In some implementations, the computing devices 2110 can obtain from and/or store data in one or more memory devices that are remote from the computing system 2105 such as one or more memory devices of the computing system 2150.

The computing devices 2110 can also include a communication interface 2135 used to communicate with one or more other systems (e.g., computing system 2150). The communication interface 2135 can include any circuits, components, software, etc. for communicating via one or more networks (e.g., 2145). In some implementations, the communication interface 2135 can include for example, one or more of a communications controller, receiver, transceiver, transmitter, port, conductors, software and/or hardware for communicating data/information.

The computing system 2150 can include one or more computing devices 2155. The computing devices 2155 can include one or more processors 2160 and a memory 2165. The one or more processors 2160 can be any suitable processing device (e.g., a processor core, a microprocessor, an ASIC, a FPGA, a controller, a microcontroller, etc.) and can be one processor or a plurality of processors that are operatively connected. The memory 2165 can include one or more non-transitory computer-readable storage media, such as RAM, ROM, EEPROM, EPROM, one or more memory devices, flash memory devices, etc., and combinations thereof.

The memory 2165 can store information that can be accessed by the processors 2160. For instance, the memory 2165 (e.g., one or more non-transitory computer-readable storage mediums, memory devices) can store data 2175 that can be accessed e.g., obtained, received, written, manipulated, created, stored, pulled, etc. The data 2175 can include, for instance, any data or information described herein. In some implementations, the computing system 2150 can obtain data from one or more memory devices that are remote from the computing system 2150.

The memory 2165 can also store computer-readable instructions 2170 that can be executed by the processors 2160. The instructions 2170 can be software written in any suitable programming language or can be implemented in hardware. Additionally, or alternatively, the instructions 2170 can be executed in logically and/or virtually separate threads on processors 2160. For example, the memory 2165 can store instructions 2170 that when executed by the processors 2160 cause the processors 2160 to perform any of the operations and/or functions described herein, including, for example, any of the processes/methods described herein or the operations and functions of any of the computing systems (e.g., aerial transportation platform system, ground transportation platform system, third party provider system, airspace system, etc.) or computing devices (e.g., user devices, ground vehicle devices, aircraft devices, aerial facility devices facility operator user devices, computing device 1500, etc.), as described herein.

The computing devices 2155 can also include a communication interface 2180 used to communicate with one or more other systems. The communication interface 2180 can include any circuits, components, software, etc. for communicating via one or more networks (e.g., 2145). In some implementations, the communication interface 2180 can include for example, one or more of a communications controller, receiver, transceiver, transmitter, port, conductors, software and/or hardware for communicating data/information.

The networks 2145 can be any type of network or combination of networks that allows for communication between devices. In some implementations, the networks 2145 can include one or more of a local area network, wide area network, the Internet, secure network, cellular network, mesh network, peer-to-peer communication link and/or some combination thereof and can include any number of wired or wireless links. Communication over the networks 2145 can be accomplished, for instance, via a network interface using any type of protocol, protection scheme, encoding, format, packaging, etc.

FIG. 14 illustrates one example system 2100 that can be used to implement the present disclosure. Other computing systems can be used as well. Computing tasks discussed herein as being performed at computing devices remote from a vehicle/device can instead be performed at the vehicle/device, or vice versa. Such configurations can be implemented without deviating from the scope of the present disclosure.

### Additional Disclosure

The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art.

Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein. The term “or” should be understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. At times, elements can be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. can be performed before, after, or in parallel with another operation illustrated by a list identifier of (b), (ii), etc.

What is claimed is:

1. A method for computing an aircraft operating state, comprising:
accessing, with one or more computing devices, data corresponding to a position and a velocity of a telemetry system for an aircraft;
accessing, with the one or more computing devices, data corresponding to a scheduled flight operation for the aircraft;
computing, with the one or more computing devices, an operating state for the aircraft based on at least one of the data corresponding to the position and the velocity of the aircraft for the telemetry system or the data corresponding to the scheduled flight operation for the aircraft; and
computing, with the one or more computing devices, an updated flight event log for the aircraft based on the operating state for the aircraft.

2. The method of claim 1, wherein the telemetry system comprises an automatic dependent surveillance-broadcast system of the aircraft.

3. The method of claim 1, wherein the scheduled flight operation for the aircraft comprises a scheduled time of departure for the aircraft.

4. The method of claim 1, wherein the operating state for the aircraft comprises one of:
an off-block operating state;
a takeoff operating state;
a landing operating state; or
an in-block operating state.

5. The method of claim 4, wherein each of the off-block operating state, the takeoff operating state, the landing operating state, and the in-block operating state are computed no greater than two minutes from a respective actual operating state time.

6. The method of claim 4, further comprising computing, with the one or more computing devices, an updated flight plan for the aircraft based on at least one of an average block time or an average flight time.

7. The method of claim 4, further comprising:
accessing, with the one or more computing devices, data corresponding to the position for the aircraft in response to detection of the landing operating state; and
computing, with the one or more computing devices, a diversion of the aircraft from the scheduled flight operation when the position for the aircraft does not match a scheduled destination for the aircraft.

8. The method of claim 4, further comprising computing, with the one or more computing devices, a touch-and-go log update for the aircraft based on the takeoff operating state and the landing operating state.

9. The method of claim 1, wherein computing the operating state for the aircraft comprises computing the operating state for the aircraft based on the data corresponding to the scheduled flight operation for the aircraft when the data corresponding to the position and the velocity of the aircraft for the telemetry system is older than a threshold time period.

10. The method of claim 1, further comprising adjusting, with the one or more computing devices, the updated flight event log for the aircraft based on an override input by a pilot of the aircraft.

11. A computing system, comprising:
one or more processors; and
one or more non-transitory computer-readable media storing instructions that are executable by the one or more processors to perform operations, the operations comprising
accessing data corresponding to a position and a velocity of a telemetry system for an aircraft,
accessing data corresponding to a scheduled flight operation for the aircraft,
computing an operating state for the aircraft based on at least one the data corresponding to the position and the velocity of the aircraft for the telemetry system or the data corresponding to the scheduled flight operation for the aircraft, and
computing an updated flight event log for the aircraft based on the operating state for the aircraft.

12. The computing system of claim 11, wherein the operating state for the aircraft comprises one of:
an off-block operating state;
a takeoff operating state;
a landing operating state; or
an in-block operating state.

13. The computing system of claim 12, wherein the operations further comprise computing an updated flight plan for the aircraft based on at least one of an average block time or an average flight time.

14. The computing system of claim 12, wherein the operations further comprise:
accessing data corresponding to the position for the aircraft in response to detection of the landing operating state; and
computing a diversion of the aircraft from the scheduled flight operation when the position for the aircraft does not match a scheduled destination for the aircraft.

15. The computing system of claim 11, wherein computing the operating state for the aircraft comprises computing the operating state for the aircraft based on the data corresponding to the scheduled flight operation for the aircraft when the data corresponding to the position and the velocity of the aircraft for the telemetry system is older than a threshold time period.

16. A non-transitory computer-readable media storing instructions that are executable by one or more processors to cause the one or more processors to perform operations, the operations comprising:
accessing data corresponding to a position and a velocity of a telemetry system for an aircraft;
accessing data corresponding to a scheduled flight operation for the aircraft;
computing an operating state for the aircraft based on at least one of the data corresponding to the position and the velocity of the aircraft for the telemetry system or the data corresponding to the scheduled flight operation for the aircraft; and
computing an updated flight event log for the aircraft based on the operating state for the aircraft.

17. The non-transitory computer-readable media of claim 16, wherein the operating state for the aircraft comprises one of:
an off-block operating state;
a takeoff operating state;
a landing operating state; or
an in-block operating state.

18. The non-transitory computer-readable media of claim 17, wherein the operations further comprise computing an average block time for the aircraft based on the off-block operating state and the in-block operating state.

19. The non-transitory computer-readable media of claim 17, wherein the operations further comprise computing a flight time of a pilot of the aircraft based on the takeoff operating state and the landing operating state.

20. The non-transitory computer-readable media of claim 17, wherein the operations further comprise:
accessing data corresponding to the position for the aircraft in response to detection of the landing operating state; and
computing a diversion of the aircraft from the scheduled flight operation when the position for the aircraft does not match a scheduled destination for the aircraft.
